(19) United States
(12) Patent Application Publication
(10) Pub. No.: US 2006/0178272 A1
(43) Pub. Date: Aug. 10, 2006

(54) Spray-on weed blocking film

(76) Inventors: Steven A. Buono, Afton, TN (US); Joseph W. Ferraro, Elizabeth, PA (US)

Correspondence Address: LUEDEKA, NEELY & GRAHAM, P.C., P O BOX 1871, KNOXVILLE, TN, 37901, US

(21) Appl. No.: 11/053,208

(22) Filed: Feb. 8, 2005

(51) Int. Cl. A01N 25/12

(52) U.S. Cl. 504/367

(57) ABSTRACT

The invention provides a weed blocking film that may be sprayed over existing mulch in a plant bed. The sprayed-on mixture hardens into a continuous barrier that passes water but blocks light to suppress weed growth. The components of the mixture are environmentally safe and will not harm desirable plants around which it is sprayed. A preferred embodiment of the mixture comprises a binding agent, a wetting agent, a dispersing agent, a stabilizing agent and a filler material, where total solids preferably comprise about 40-60 percent by weight of the mixture. In one embodiment, the binding agent comprises an emulsion polymer, the wetting agent comprises an alkyl ethoxylate, the dispersing agent comprises a polymer-based polycarboxylate, the thickening agent comprises a hydrophobic-modified carboxymethyl cellulose, and the filler comprises powdered clay.

### FIELD

This invention relates to the field of horticultural mulching. More particularly the invention relates to a continuous mulch film which is water semi-permeable and which is applied by a spray process.

### BACKGROUND

A variety of materials have been used as horticultural mulch to enhance plant growth, suppress weeds, conserve moisture and improve soil conditions in soil around ornamental plants. Generally, these materials are applied in plant beds to conserve water, elevate soil temperature, control weeds, and add organic mater to soils. Straw, peat moss, compost, manure, shredded bark and wood, and gravel have all been used as mulch. Each of these mulch materials have one or more deficiencies with regard to weed suppression and moisture retention performance.

Recently, plastic film and fabric sheet materials have been preferred for use as mulch due to their low material cost and effectiveness in weed control and elevation of soil temperature. However, these materials have several disadvantages, including poor distribution of irrigated water and the need for periodic removal and replacement. Replacement of plastic film and fabric sheeting material around ornamental plants is labor-intensive and hence quite expensive.

Spray-on materials have also been developed for weed control. Unfortunately, prior spray-on materials have several disadvantages that have deterred their widespread use. Many are applied as a foam, which requires specialized and often expensive application tools. Foamed materials also have a relatively low concentration of solids and thus do not form an evenly thick and continuous barrier as is preferred for weed prevention. Some of the spray-on materials contain components that are harmful or potentially harmful to the environment.

What is needed, therefore, is a coating material having improved weed suppression and moisture retention performance, which provides an evenly thick and continuous barrier over the ground, which is not harmful to the environment, which may be applied without specialized and expensive equipment, and which is applied with relatively little labor.

### SUMMARY

The above and other needs are met by a sprayable fluid mixture that hardens into a continuous barrier that passes water but blocks light to suppress weed growth. In some embodiments, mulch material such as shredded paper or sawdust may be sprayed into the plant bed first, followed by a layer of the weed blocker spray. The components of the mixture are environmentally safe and will not harm desirable plants around which it is sprayed. The mixture may be sprayed over existing mulch with substantially no preparation work.

In a most preferred embodiment, the mixture comprises a binding agent, a wetting agent, a dispersing agent, a stabilizing agent, a filler material and water, wherein total solids comprise about 40-60 percent by weight of the mixture. Also in a preferred embodiment, the binding agent comprises about 10-50 percent by weight of the mixture, the wetting agent comprises no greater than about 10 percent, the dispersing agent comprises about 0.5-5 percent, the stabilizing agent comprises about 0.2-4 percent, and the filler material comprises about 20-40 percent.

In another preferred embodiment, the binding agent comprises an emulsion polymer, the wetting agent comprises an alkyl ethoxylate, alkyl ethoxylate sulfate or alkyl aryl sulfonate, the dispersing agent comprises a polymer-based polycarboxylate, the thickening agent comprises a polymer-based and/or natural thickener, such as hydrophobic-modified carboxymethyl cellulose, and the filler comprises powdered clay, such as calcium carbonate or kaolin.

In yet another preferred embodiment, the mixture comprises a binding agent, a wetting agent, a dispersing agent, a stabilizing agent, a filler material and water, wherein total solids comprise about 40-60 percent by weight of the mixture.

### DETAILED DESCRIPTION

The invention comprises a fluid mixture designed to be sprayed on the ground around desirable plants to form a film barrier to prevent the growth of weeds within a plant bed. The components of a preferred embodiment of the mixture are listed in Table I. As the percentages listed in Table I indicate, the mixture is designed to be concentrated, with solids (such as latex and filler) preferably comprising well over 50% of the mixture. This provides for a continuous and evenly distributed film when sprayed on the ground using conventional spraying equipment, such as paint spraying equipment.

As Table I also indicates, the mixture of the present invention includes a substantial amount of filler. In the preferred embodiment, filler comprises 20% or more of the mixture. This is in sharp contrast to prior spray-on materials applied as a foam, where filler amounts above about 2% would inhibit the foam formation.

One of the considerations in the selection of the materials listed in Table I is that each is easy to obtain and inexpensive. Thus, besides providing a spray-on film that has proven to be an effective weed blocker and benign to the environment, the invention also provides a mixture that is easy and inexpensive to make.

Preferably, the mixture is sprayed onto the ground to form a continuous film having a thickness of about 0.002-0.006 inch. In this thickness range, the film is substantially water permeable but still effectively prevents weeds from growing through.

In one embodiment, herbicides and/or insecticides may be added to the mixture to further deter weed growth and insect infestation.

TABLE I

| | Percent | | | | | |
|---|---|---|---|---|---|---|
| Material | (weight) | Composition | Description | Purpose | Product | Manufacturer |
| latex | 40 | styrene- | aqueous | binding | GenFlo 3003 | Omnova |
| (lattice) | | butadiene | dispersion | agent | Rovene 4457 | Mallard- |
| | | emulsion | | | | Creek |
| | | polymer | | | | |
| | | ethylene vinyl | aqueous | binding | Airflex 811 | Air Products |
| | | acetate | dispersion | agent | and RB11 | |
| | | emulsion | | | | |
| | | polymer | | | | |
| | | vinyl acrylic | aqueous | binding | Flexbond 325 | Air Products |
| | | emulsion | dispersion | agent | | |
| surfactant | 0.5 | alkyl ethoxylate | nonionic | wetting | Trycol 6984 | Cognis |
| | | | surfactant | agent | Makon OP9 | Stepan |
| | | | | | (Octylphenol + | |
| | | | | | 9 EO units) | |
| | | alkyl ethoxylate | anionic | wetting | Disponil FES | Cognis |
| | | sulfate | surfactant | agent | 32 | |
| | | alkyl aryl | anionic | wetting | Polystep LAS- | Stepan |
| | | sulfonate | surfactant | agent | 50 | |
| dispersant | 3 | poly carboxylate | aqueous | dispersing | Hydorpalat 44 | Cognis |
| | | (polymer-based) | polymer | diagent | (34% TS) | Rohm and |
| | | | solution | | Tamol 731 or | Haas |
| | | | | | Tamol 524 | |
| thickener | 3 | hydrophobic- | aqueous | stabilizing | Natrosol FPS | Hercules |
| | | modified | polymer | agent | plus fluidized | |
| | | carboxymethyl | suspension | | polymer | |
| | | cellulose | | | suspension | |
| | | | | | (38% TS) | |
| filler | 25 | powdered clay | powder | filler and | #10 White | Imerys |
| | | (calcium | | extender | (100% TS | |
| | | carbonate) | | | Calcium | |
| | | | | | Carbonate) | |
| | | powdered clay | powder | filler and | Kaolin clay | Imerys |
| | | | | extender | | |
| water | 28.5 | — | hot water | — | — | — |

TABLE II

| | Weight | Active Solids | Preferred Range |
|---|---|---|---|
| Material | (parts per 100) | (parts per 100) | (% by wt) |
| water | 28.5 | 0 | variable |
| surfactant | 0.5 | 0.05 × 1.00 = 0.5 | 0-5 |
| thickener | 3.0 | 3.0 × 0.38 = 1.14 | 0.2-4 |
| dispersant | 3.0 | 3.0 × 0.34 = 1.02 | 0.5-5 |
| filler | 25.0 | 25.0 × 1.00 = 25 | 20-40 |
| latex | 40.0 | 40.0 × 0.52 = 20.8 | 10-50 |
| total | 100.0 | 48.46 | 40-60 |

In one embodiment of the invention, the mixture includes alcohol to speed the drying of the film after it has been sprayed onto a surface. Preferably, the amount of alcohol in the mixture does not exceed about 7 percent.

According to a preferred embodiment of the invention, a 100 gram sample of the mixture may be formed by premixing the surfactant, dispersant, thickener, filler and about one half of the water using a high shear mixer for at least about 60 seconds. The latex and the remaining water are then added and mixed in with the high shear mixer for about 60 seconds. It is preferable that the water be warm or hot to aid in the dispersal of the materials in the mixture.

According to an alternative embodiment of the invention, the mixture may be formed by adding all of the materials to a mix tank, beginning with the water, and mixing with a high shear mixer for at least about one to two minutes.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as is suited to the particular use contemplated. All such modifications and variations are within the scope of the invention as determined by the appended claims when interpreted in accordance with the breadth to which they are fairly, legally, and equitably entitled.

1. A mixture for application upon an area to prevent growth of unwanted plants therein, the mixture comprising:
a binding agent comprising no less than about 10 percent by weight and no greater than about 50 percent by weight of the mixture;
a wetting agent comprising no greater than about 10 percent by weight of the mixture;
a dispersing agent comprising no less than about 0.5 percent by weight and no greater than about 5 percent by weight of the mixture;
a stabilizing agent comprising no less than about 0.2 percent by weight and no greater than about 4 percent by weight of the mixture; and
a filler material comprising no less than about 20 percent by weight and no greater than about 40 percent by weight of the mixture.

2. The mixture of claim 1 wherein total solids comprise no less than about 40 percent by weight and no greater than about 60 percent by weight of the mixture.

3. The mixture of claim 1 wherein the binding agent comprises an emulsion polymer.

4. The mixture of claim 1 wherein the binding agent comprises an emulsion polymer selected from the group consisting of styrene-butadiene and ethylene vinyl acetate.

5. The mixture of claim 1 wherein the binding agent comprises a vinyl acrylic emulsion.

6. The mixture of claim 1 wherein the wetting agent is selected from the group consisting of alkyl ethoxylate, alkyl ethoxylate sulfate and alkyl aryl sulfonate.

7. The mixture of claim 1 wherein the dispersing agent comprises a polymer-based polycarboxylate.

8. The mixture of claim 1 wherein the thickening agent comprises a hydrophobic-modified carboxymethyl cellulose.

9. The mixture of claim 1 wherein the filler comprises powdered clay.

10. The mixture of claim 9 wherein the filler comprises calcium carbonate.

11. The mixture of claim 1 wherein:
the binding agent is selected from the group consisting of emulsion polymers and vinyl acrylic emulsions;
the wetting agent is selected from the group consisting of alkyl ethoxylate, alkyl ethoxylate sulfate and alkyl aryl sulfonate;
the dispersing agent comprises an polymer-based polycarboxylate;
the thickening agent comprises a hydrophobic-modified carboxymethyl cellulose; and
the filler comprises powdered clay.

12. A mixture for application upon an area to prevent growth of unwanted plants therein, the mixture comprising:
a binding agent selected from the group consisting of emulsion polymers and vinyl acrylic emulsions;
a wetting agent selected from the group consisting of alkyl ethoxylate, alkyl ethoxylate sulfate and alkyl aryl sulfonate;
a dispersing agent comprising an polymer-based polycarboxylate;
a thickening agent comprising a hydrophobic-modified carboxymethyl cellulose; and
a filler comprising powdered clay.

13. The mixture of claim 12 wherein the binding agent is an emulsion polymer selected from the group consisting of styrene-butadiene and ethylene vinyl acetate.

14. The mixture of claim 12 wherein the binding agent comprises no less than about 10 percent by weight and no greater than about 50 percent by weight of the mixture.

15. The mixture of claim 12 wherein the wetting agent comprises no greater than about 10 percent by weight of the mixture.

16. The mixture of claim 12 wherein the dispersing agent comprises no less than about 0.5 percent by weight and no greater than about 5 percent by weight of the mixture.

17. The mixture of claim 12 wherein the stabilizing agent comprises no less than about 0.2 percent by weight and no greater than about 4 percent by weight of the mixture.

18. The mixture of claim 12 wherein the filler material comprises no less than about 20 percent by weight and no greater than about 40 percent by weight of the mixture.

19. The mixture of claim 12 wherein total solids comprise no less than about 40 percent by weight and no greater than about 60 percent by weight of the mixture.

20. A mixture for application upon an area to prevent growth of unwanted plants therein, the mixture comprising a binding agent, a wetting agent, a dispersing agent, a stabilizing agent, a filler material and water, wherein total solids comprise no less than about 40 percent by weight and no greater than about 60 percent by weight of the mixture.

21. A product for surface application to soil comprising a fluid mixture wherein total solids comprise no less than about 40 percent by weight and no greater than about 60 percent by weight.

22. The product of claim 21 further comprising the mixture for spray application upon the soil.

23. The product of claim 21 further comprising the mixture for increasing moisture retention of the soil.

24. The product of claim 21 further comprising the mixture for suppressing growth of unwanted plants in the soil.

25. The product of claim 21 wherein the mixture comprises a binding agent, a wetting agent, a dispersing agent, a stabilizing agent and a filler material.

26. The product of claim 25 wherein
the binding agent is selected from the group consisting of emulsion polymers and vinyl acrylic emulsions,
the wetting agent is selected from the group consisting of alkyl ethoxylate, alkyl ethoxylate sulfate and alkyl aryl sulfonate,
the dispersing agent comprises an polymer-based polycarboxylate,
the thickening agent comprises a hydrophobic-modified carboxymethyl cellulose, and
the filler comprises powdered clay.

27. The product of claim 25 wherein
the binding agent comprises no less than about 10 percent by weight and no greater than about 50 percent by weight of the mixture,
the wetting agent comprises no greater than about 10 percent by weight of the mixture,
the dispersing agent comprises no less than about 0.5 percent by weight and no greater than about 5 percent by weight of the mixture,
the stabilizing agent comprises no less than about 0.2 percent by weight and no greater than about 4 percent by weight of the mixture, and
the filler material comprises no less than about 20 percent by weight and no greater than about 40 percent by weight of the mixture.

28. A product for surface application to soil comprising a mixture of:
a binding agent selected from the group consisting of emulsion polymers and vinyl acrylic emulsions;
a wetting agent selected from the group consisting of alkyl ethoxylate, alkyl ethoxylate sulfate and alkyl aryl sulfonate;
a dispersing agent comprising an polymer-based polycarboxylate;
a thickening agent comprising a hydrophobic-modified carboxymethyl cellulose; and
a filler comprising powdered clay.

29. The product of claim 28 further comprising the mixture for spray application on the soil.

30. The product of claim 28 further comprising the mixture for increasing moisture retention of the soil.

31. The product of claim 28 further comprising the mixture for suppressing growth of unwanted plants in the soil.

32. The product of claim 28 wherein
the binding agent comprises no less than about 10 percent by weight and no greater than about 50 percent by weight of the mixture,
the wetting agent comprises no greater than about 10 percent by weight of the mixture,
the dispersing agent comprises no less than about 0.5 percent by weight and no greater than about 5 percent by weight of the mixture,
the stabilizing agent comprises no less than about 0.2 percent by weight and no greater than about 4 percent by weight of the mixture, and
the filler material comprises no less than about 20 percent by weight and no greater than about 40 percent by weight of the mixture.

33. The product of claim 32 wherein total solids comprise no less than about 40 percent by weight and no greater than about 60 percent by weight of the mixture.

34. A product for surface application to soil comprising a mixture of:
a binding agent comprising no less than about 10 percent by weight and no greater than about 50 percent by weight of the mixture;
a wetting agent comprising no greater than about 10 percent by weight of the mixture;
a dispersing agent comprising no less than about 0.5 percent by weight and no greater than about 5 percent by weight of the mixture;
a stabilizing agent comprising no less than about 0.2 percent by weight and no greater than about 4 percent by weight of the mixture; and
a filler material comprising no less than about 20 percent by weight and no greater than about 40 percent by weight of the mixture.

35. The product of claim 34 further comprising the mixture for spray application on the soil.

36. The product of claim 34 further comprising the mixture for increasing moisture retention of the soil.

37. The product of claim 34 further comprising the mixture for suppressing growth of unwanted plants in the soil.

38. A product for surface application to soil comprising a mixture of:
a binding agent selected from the group consisting of emulsion polymers and vinyl acrylic emulsions; and
a wetting agent selected from the group consisting of alkyl ethoxylate, alkyl ethoxylate sulfate and alkyl aryl sulfonate.

39. The product of claim 38 wherein the mixture further comprises a dispersing agent comprising an polymer-based polycarboxylate.

40. The product of claim 38 wherein the mixture further comprises a thickening agent comprising a hydrophobic-modified carboxymethyl cellulose.

41. The product of claim 38 wherein the mixture further comprises a filler comprising powdered clay.

42. The product of claim 38 wherein the mixture further comprises:
a dispersing agent comprising an polymer-based polycarboxylate; and
a thickening agent comprising a hydrophobic-modified carboxymethyl cellulose.

43. A product for surface application to soil comprising a mixture of:
a binding agent selected from the group consisting of emulsion polymers and vinyl acrylic emulsions; and
a dispersing agent comprising an polymer-based polycarboxylate.

44. The product of claim 43 wherein the mixture further comprises a wetting agent selected from the group consisting of alkyl ethoxylate, alkyl ethoxylate sulfate and alkyl aryl sulfonate.

45. The product of claim 43 wherein the mixture further comprises a thickening agent comprising a hydrophobic-modified carboxymethyl cellulose.

46. The product of claim 43 wherein the mixture further comprises a filler comprising powdered clay.
